(19) United States
(12) Patent Application Publication
(10) Pub. No.: US 2014/0177160 A1
(43) Pub. Date: Jun. 26, 2014

(54) CHIP CARD HOLDER FOR PORTABLE ELECTRONIC DEVICES

(71) Applicants: FIH (HONG KONG) LIMITED, Kowloon (HK); SHENZHEN FUTAIHONG PRECISION INDUSTRY CO., LTD., Shenzhen (CN)

(72) Inventor: YAN-LING GAO, Shenzhen (CN)

(73) Assignees: FIH (HONG KONG) LIMITED, Kowloon (HK); SHENZHEN FUTAIHONG PRECISION INDUSTRY CO., LTD., Shenzhen (CN)

(21) Appl. No.: 14/014,942

(22) Filed: Aug. 30, 2013

(30) Foreign Application Priority Data
Dec. 20, 2012 (CN) 2012105576920

(51) Int. Cl. G06F 1/16

(52) U.S. Cl. CPC G06F 1/1658
USPC 361/679.32

(57) ABSTRACT

A chip card holder includes a housing, a receiving frame, an elastic member, a tray, and a protective cover. The housing defines two holes. The receiving frame is mounted in the housing. The tray is slidably received in the receiving frame. The protective cover is slidably connected to the housing to cover the holes. The elastic member torsionally connects the tray to the protective cover. After the protective cover is slid along the housing and is unlocked from the housing, the elastic member pulls the tray from the housing.

### BACKGROUND

1. Technical Field

The present disclosure relates to chip card holders, and particularly to a chip card holder for a portable electronic device.

2. Description of Related Art

With the development of wireless communication and information processing technologies, portable electronic devices, such as mobile phones, are now widely used. Chip cards are necessary elements in portable electronic devices.

A chip card holder uses a tray for holding the chip card. The tray needs to be pulled out of the housing for convenient insertion and removal of the chip card.

Therefore, there is room for improvement within the art.

### BRIEF DESCRIPTION OF THE DRAWINGS

Many aspects of the embodiments can be better understood with reference to the drawings. The components in the drawings are not necessarily drawn to scale, the emphasis instead being placed upon clearly illustrating the principles of the chip card holder and portable electronic device using the chip card holders. Moreover, in the drawings, like reference numerals designate corresponding parts throughout the several views. Wherever possible, the same reference numbers are used throughout the drawings to refer to the same or like elements of an embodiment.

FIG. 1 is an exploded view of one embodiment of a chip card holder used in a portable electronic device.

FIG. 2 is an enlarged view of a protective cover of FIG. 1, shown from another aspect.

FIG. 3 shows the protective cover attached to a housing in a locked state.

FIGS. 4 and 5 show the chip card holder assembled to the housing in a locked state.

FIG. 6 shows the protective cover in an unlocked state.

FIG. 7 is similar to FIG. 6, but shows the protective cover unlocked from the housing.

### DETAILED DESCRIPTION

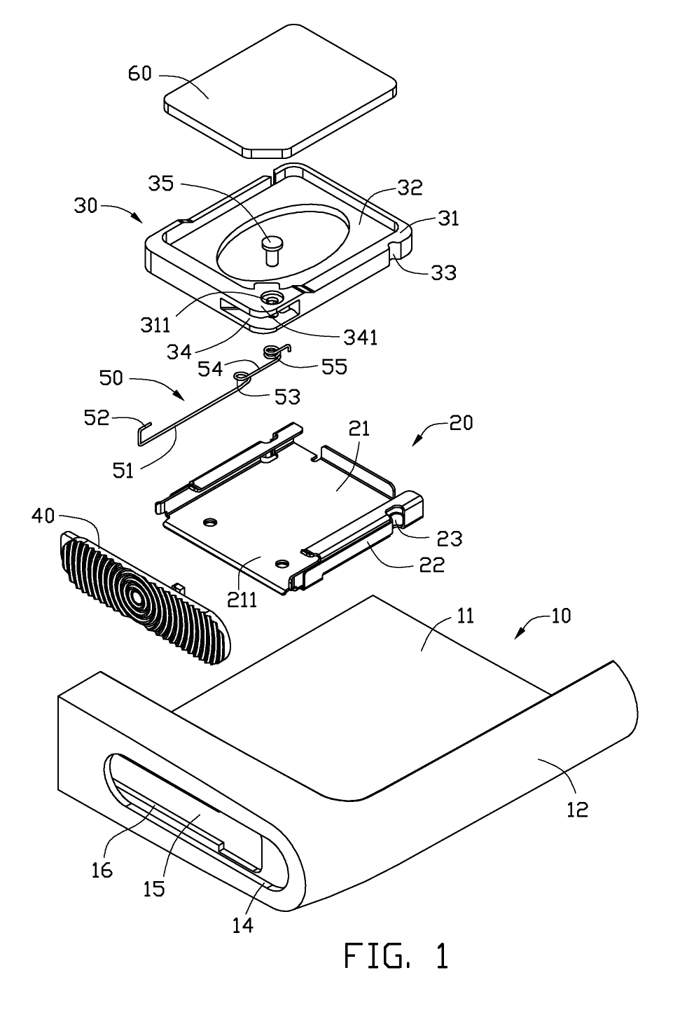

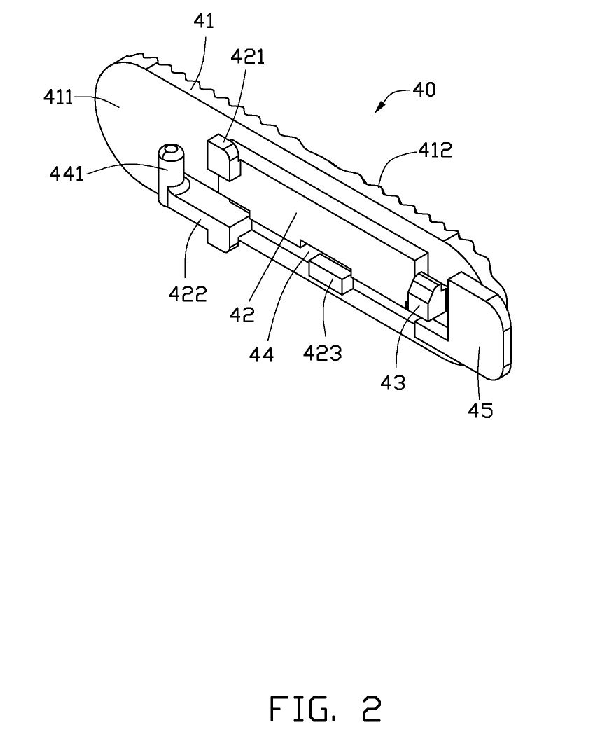

FIGS. 1 to 3 show an embodiment of a chip card holder, which can be used in a portable electronic device, such as a cellular phone, or any other electronic device where a chip card is required. The portable electronic device includes a housing 10. The chip card holder is assembled in the housing 10. A chip card 60 is placed in the chip card holder. The chip card 60 can be a subscriber identity module (SIM) card or a flash card, for example.

The chip card holder includes a receiving frame 20, a tray 30, a protective cover 40, and an elastic member 50.

The housing 10 can be a portion of the portable electronic device or a separate element fixed to the portable electronic device. In one embodiment, the housing 10 is a bottom portion of the portable electronic device. The housing 10 includes a main body 11, and an end wall 12 integrated with the main body 11. The end wall 12 defines a first hole 14 in an exterior surface thereof, and defines a second hole 15 in an interior surface thereof. The second hole 15 is partially aligned with the first hole 14, thereby forming a stopper portion 16 between the first hole 14 and the second hole 15. The chip card holder is received inside the housing 10 through the first hole 14 and the second hole 15, and is supported by the main body 11.

The receiving frame 20 is secured on the main body 11 adjacent to and aligned with the first hole 14 and the second hole 15. The receiving frame 20 includes a frame body 21 and two opposite flanges 22. The frame body 21 and the flanges 22 cooperatively define a receiving cavity communicating with the second hole 15 and the first hole 14 for receiving the tray 30. An entrance 211 is defined at one end of the receiving cavity to allow the tray 30 to be inserted inside. One end of each flange 22 forms a latching portion 23 extending into the receiving cavity.

The tray 30 includes a tray body 31 slidably received in the receiving frame 20. The tray body 31 defines a receiving space 32 in one surface for receiving the chip card 60. The tray body 31 defines a latching groove 33 in opposite sides for engaging with the latching portions 23. A corner of the tray body 31 defines a recess 34, thereby forming two extending plates 341 at opposite sides of the recess 34, respectively. Each extending plate 341 defines a fastener hole 311 for receiving a fastener 35.

The protective cover 40 is configured for slidably engaging in the first hole 14 and the second hole 15 for protecting and stopping the tray 30. The protective cover 40 includes a plate body 41 and a subsidiary plate 42. The plate body 41 has a first surface 411 and a second surface 412 opposite to each other. The second surface 412 forms a plurality of ribs to provide a gripping surface for convenient manipulation of the protective cover 40. The subsidiary plate 42 is formed on the first surface 411. One end of the subsidiary plate 42 has a latching block 421, and a first limiting block 422 is located adjacent to and spaced from the latching block 421. One end of the first limiting block 422 has a post 441 spaced from the first surface 411. Another end of the subsidiary plate 42 has a hook 43 and an extending plate 45 adjacent to and spaced from the hook 43. A second limiting block 423 is formed at one side of the subsidiary plate 42, and is positioned between the first limiting block 422 and the extending plate 45. The first limiting block 422, the second limiting block 423, and the extending plate 45 are spaced from one edge of the subsidiary plate 42 to define a receiving groove 44 for accommodating the elastic member 50.

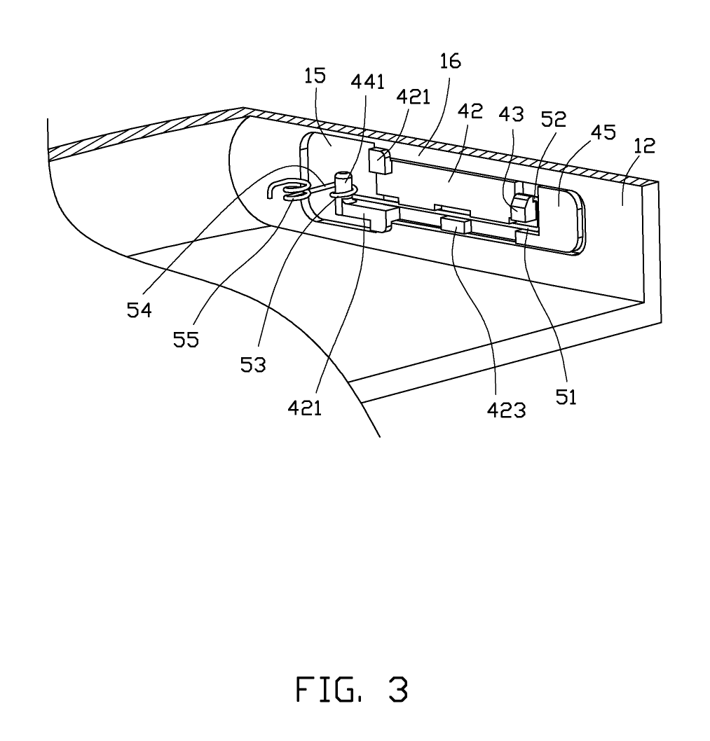

Referring to FIG. 3, the elastic member 50 is a metal wire that has been coiled and bent at predetermined locations. The elastic member 50 includes a first wire part 51, a latching end 52, a first torsional portion 53, a second wire part 54, and a second torsional portion 55. The first wire part 51 is received in the receiving groove 44. The latching end 52 is formed at one end of the first wire part 51, and is latched with the hook 43. The second wire part 54 is positioned between the first torsional portion 53 and the second torsional portion 55. The first torsional portion 53 is fitted around the post 441. The second torsional portion 53 is received in the recess 34, and is secured in the tray 30 by the fastener 35. In a free state, the first wire part 51 and the second wire part 54 are substantially parallel.

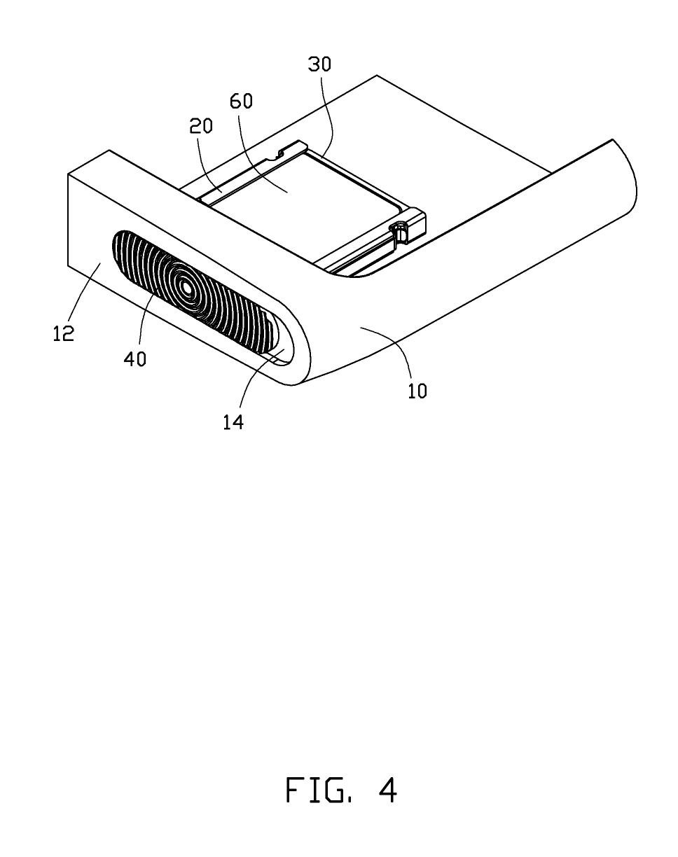

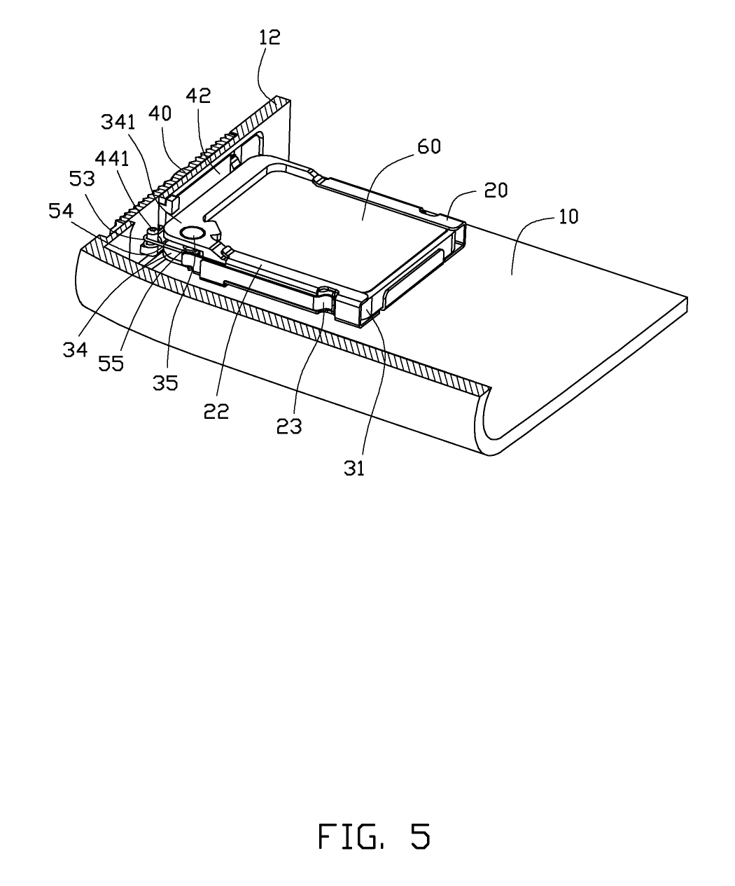

During assembly, referring to FIGS. 4-5, the receiving frame 20 is mounted on the main body 11 of the housing 10 by hot melting. The entrance 211 of the receiving frame 20 is aligned with the overlapping parts of the first hole 14 and the second hole 15. The second torsional portion 55 of the elastic member 50 is secured by the fastener 35 in the recess 34. The tray 30 with the elastic member 50 is inserted inside the housing 10 through the first hole 14 and the second hole 15. The tray 30 is slidably received in the receiving cavity and is retained by the flanges 22. The protective cover 40 is assembled with the elastic member 50. The first torsional portion 53 is fitted around the post 441, and the latching end 52 is latched to the hook 43 of the protective cover 40. The first wire part 51 is received in the guiding groove 44. After the elastic member 50 is assembled to the protective cover 40, the second wire part 54 is bent relative to the first wire part 51, and the protective cover 40 is kept in a tilted state relative to the housing 10. To engage the protective cover 40 in the housing 10, the protective cover 40 is pressed toward the inside of the housing 10. The protective cover 40 is rotated about the first torsional portion 53 until the plate body 41 and the subsidiary plate 42 are aligned with the first hole 14. The protective cover 40 is slid along the first hole 14 until the stopper portion 16 blocks the latching block 421 and the extending plate 45. At this time, the protective cover 40 is locked in the housing 10. The first wire part 51 of the elastic member 50 is rotated about 90 degrees relative to the second wire part 54 to increase a torsional force holding the protective cover 40 in the locked state. Thus, the assembly process of the chip card holder in the housing 10 is finished.

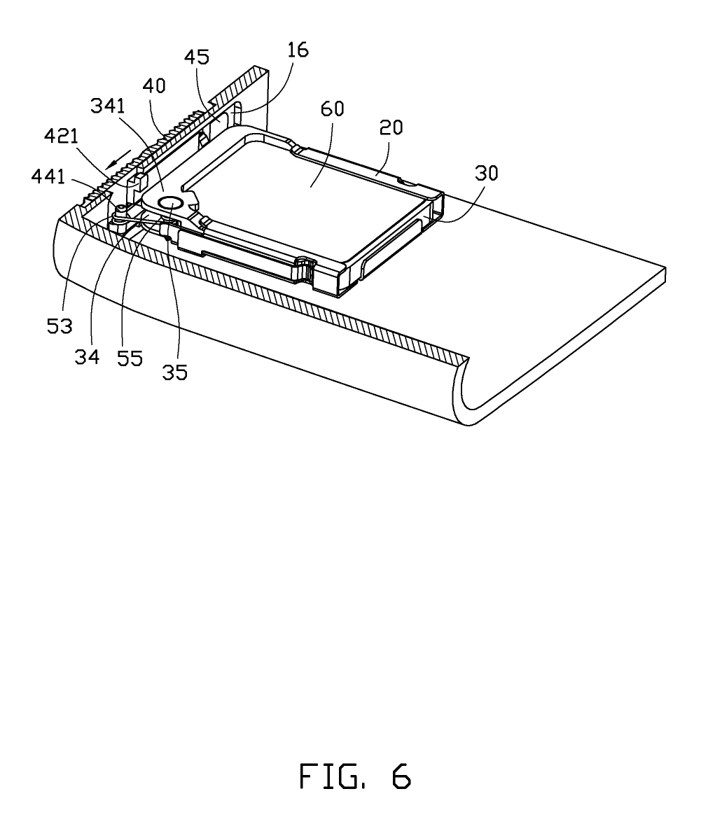

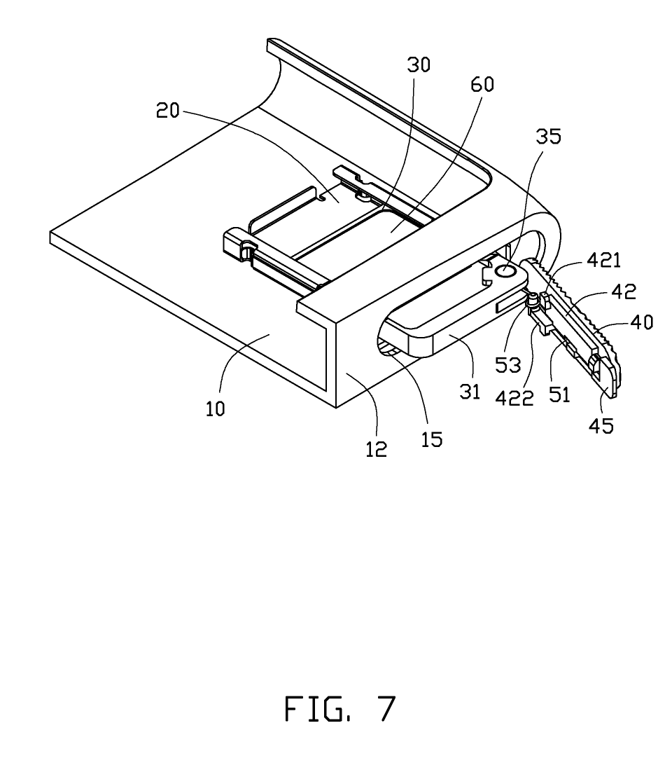

Referring to FIGS. 6 and 7, to remove the chip card, the protective cover 40 is slid along the first hole 14 and the second hole 15 until the latching block 421 and the extending plate 45 are not blocked by the stepped portion 16. The tray 30 is pulled out of the receiving cavity by the restoring force of the first wire part 51 of the elastic member 50. The tray 30 is then manually pulled out of the first hole 14 and the second hole 15, and removed from the receiving frame 20. The chip card 60 can now be easily removed from the tray 30.

As described above, the embodiment provides a chip card holder for portable electronic devices, such as mobile phones. The chip card holder can be easily opened, and the protective cover 40 can effectively hide and protect the tray 30.

Although numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A chip card holder assembled to a housing, the housing defining a hole, the chip card holder comprising:
a receiving frame mounted on the housing;
a tray slidably received in the receiving frame;
a protective cover slidably connected to the housing and covering the hole; and
an elastic member torsionally connecting the tray and the protective cover;
wherein when the protective cover is slid along the housing and unlocked from the housing, the elastic member ejects the protective cover and the tray from the hole of the housing.

2. The chip card holder of claim 1, wherein the receiving frame includes a frame body and two opposite flanges cooperatively defining a receiving cavity, and an entrance is defined at one end of the frame body to allow the tray to be inserted into the receiving cavity therethrough.

3. The chip card holder of claim 1, wherein the elastic member is made of a bent metal wire.

4. The chip card holder of claim 3, wherein the elastic member includes a first wire part, a first torsional portion, a second wire part, and a second torsional portion, the second wire part is positioned between the first torsional portion and the second torsional portion, and the first wire part and the second wire part are substantially collinear in a free state.

5. The chip card holder of claim 4, further comprising a fastener, wherein the tray defines a recess, and the second torsional portion is received in the recess and mounted on the tray by the fastener.

6. The chip card holder of claim 5, wherein the tray comprises two extending plates at opposite sides of the recess, each extending plate defines a fastener hole, and the fastener extends through the fastener holes and the second torsional portion.

7. The chip card holder of claim 5, wherein the protective cover includes a plate body and a subsidiary plate, the subsidiary plate extends from one side of the plate body, the subsidiary plate comprises a post and a hook, the first torsional portion is fitted around the post, and one end of the elastic member is latched with the hook.

8. The chip card holder of claim 7, wherein the subsidiary plate comprises a latching block, a first limiting block, a second limiting block, and an extending plate, the second limiting block is formed at one side of the subsidiary plate and positioned between the first limiting block and the extending plate, and the first limiting block, the second limiting block, and the extending plate are spaced from one edge of the subsidiary plate to define a receiving groove for accommodating the first wire part of the elastic member.

9. A portable electronic device, comprising:
a housing;
a receiving frame mounted on the housing;
a tray slidably received in the receiving frame;
an elastic member, one end of the elastic member mounted on the tray; and
a protective cover slidably connected to the housing, anther end of the elastic member mounted to the protective cover;
wherein when the protective cover is slid along the housing and is unlocked from the housing, the elastic member ejects the tray and the protective cover from the housing.

10. The portable electronic device of claim 9, wherein the elastic member is made of a bent metal wire.

11. The portable electronic device of claim 10, wherein the receiving frame includes a frame body and two opposite flanges cooperatively defining a receiving cavity, and an entrance is defined at one end of the frame body to allow the tray to be inserted into the receiving cavity therethrough.

12. The portable electronic device of claim 9, wherein the elastic member includes a first wire part, a first torsional portion, a second wire part, and a second torsional portion, the second wire part is positioned between the first torsional portion and the second torsional portion, and the first wire part and the second wire part are substantially collinear in a free state.

13. The portable electronic device of claim 12, further comprising a fastener, wherein the tray defines a recess, and the second torsional portion is received in the recess and is mounted on the tray by the fastener.

14. The portable electronic device of claim 13, wherein the tray comprises two extending plates at opposite sides of the recess, each extending plate defines a fastener hole, and the fastener extends through the fastener holes and the second torsional portion.

15. A chip card holder assembled to a housing, the chip card holder comprising:
a tray slidably received in the housing in a first direction;
a protective cover slidably connected to the housing in a second direction; and
an elastic member torsionally connecting the tray and the protective cover;
wherein when the protective cover is slid along the housing in the second direction and unlocked from the housing, the elastic member ejects the protective cover and the tray from the housing in the first direction.
